(19) United States
(12) Patent Application Publication
(10) Pub. No.: US 2010/0100450 A1
(43) Pub. Date: Apr. 22, 2010

(54) MOBILE SERVICE SYSTEM AND SERVICE METHOD USING THE SAME

(75) Inventor: Young Hwan Lim, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: UNIWEBS INC.

(21) Appl. No.: 12/473,210

(22) Filed: May 27, 2009

(30) Foreign Application Priority Data
Oct. 21, 2008 (KR) 10-2008-0103222

(51) Int. Cl. G06Q 30/00; H04M 3/00; H04M 11/00; H04W 4/12

(52) U.S. Cl. 705/14.68; 455/418; 455/406; 705/14.4; 455/466

(57) ABSTRACT

The present disclosure is relate to an image comparison device using a personal video recorder, the device comprising a display unit configured to output a reference image, at least one camera configured to obtain a comparison image by taking a picture of a present scene of a subject for photography chasing a movement of an object included in the reference image while the reference image is displayed on the screen of the display unit, and a controller configured to display the comparison image with the reference image on the screen, and a method using the an image comparison device.

This application claims the benefit of the Korean Patent Application No. 10-2008-0103222, filed on Oct. 21, 2008, which is hereby incorporated by reference as if fully set forth herein.

### BACKGROUND OF THE DISCLOSURE

1. Field of the Disclosure

The present disclosure relates to a mobile system and method thereof which may easily provide contents or service which is produced by an individual through a mobile terminal, which enables to reduce the charge fee for the mobile address, and which enables a various advertisements to be advertised.

2. Discussion of the Related Art

Conventionally, a user should input all URL of a personal mobile page in accessing the personal mobile page by using the mobile terminal which is applicable in the wireless network. This manner of accessing the specific mobile page is hard for the user due to the interface of the mobile terminal. Namely, it is distinct for user to input English characters and special characters though a few limited numbers of buttons.

Therefore, various methods have been proposed to solve this problem.

### SUMMARY OF THE DISCLOSURE

An object of the present disclosure is to provide a mobile service system comprising: a WINC(a coined word) extension number generating unit configured to manage and to generate a WINC extension number; and a controller configured to control the extension number generating unit to automatically generate the WINC extension number, or to generate the WINC extension number which a mobile content or service provider selects in order to provide the WINC extension number to a mobile content or service provider, if a signal for receiving the WINC extension number is received.

In some exemplary embodiments, the mobile service system further comprises a charging data base configured to store information on a charge for the each mobile content or service provider, wherein the controller is configured to charge the fee according to a use period selection of the WINC extension number, and to control to store a charged charge information in the charging data base.

In some exemplary embodiments, the mobile service system further comprises a charging data base configured to store information on a charge for the each mobile content or service provider, wherein, the controller configured to control to reduce a charge fee or provide an additional point, and to store information on reduction of the charge fee and the additional point in the charge data base, in case that the mobile contents or service provider allows an insertion of mobile advertisement.

In some exemplary embodiments. The mobile service system further comprises a contents data base configured to store mobile contents or services; and a mobile converting unit configured to convert requested mobile contents or services stored in the contents data base to cater to an image, a resolution, a size of a screen, and a mark-up language which are able to be supported in a mobile terminal, if the signal requesting a specific mobile contents or services is received to the mobile terminal through an internet network.

In some exemplary embodiments, the mobile converting unit comprises a mobile terminal information data base configured to store information of various mobile terminals; a contents generating unit configured to convert the mobile contents or service to the mark up language supported by the mobile terminal by using the information stored in the mobile terminal information data base; and a resource converting unit configured to convert the mobile contents or services to cater to an image, a resolution, a size of a screen, and a mark-up language which are able to be supported in the mobile terminal by using the information stored in the mobile terminal information data base.

In some exemplary embodiments, the controller is configured to control the contents generating unit to transmit the mobile contents or service to the resource converting unit or to convert a converted mobile contents transmitted from the resource converting unit or service to the markup language which mobile terminal supports if the signal for converting the mobile contents or service to cater to the specification of the mobile terminal is received.

In some exemplary embodiments, the controller is configured to control the resource converting unit to convert the received mobile contents or service to cater to the size of mobile terminal's screen, a resolution, a supportable image so as to transmit to the contents generating unit if the mobile contents or service is transmitted from the contents generating unit.

In some exemplary embodiments, the controller is configured to read information corresponding to the mobile terminal information data base if the accessed mobile terminal is analyzed so that the mobile terminal's information is preexisted and is configured to control to store information in the mobile terminal information in case of a new mobile terminal where the stored information is extracted from information included in a header of an access request message from the mobile terminal.

In some exemplary embodiments, the mobile service system further comprises a communication module configured to communicate with a mobile terminal, wherein the controller is configured to transmit the converted mobile contents or service to the accessed mobile terminal by using the communication module.

In some exemplary embodiments, the controller is configured to transmit a SMS to a specific mobile terminal when a signal for sending the SMS including the mobile address to the specific mobile terminal is received, wherein the SMS is for automatically accessing to the mobile address if the mobile address is selected.

An object of the present disclosure is provide a mobile service method, comprising: selecting an item by a user, the item for constituting at least one of a WINC extension use period and mobile contents or service; providing a WINC extension number to the mobile contents or service provider by generating the WINC extension number selected by the mobile contents or service or automatically generated from a WINC extension number generating unit if the use period of the WINC extension number is selected; and uploading the mobile contents or service in a contents data base by the mobile contents or service provider.

In some exemplary embodiments, the method of claim 11, further comprising: reading the mobile contents or service corresponding the specific WINC extension number from the contents data base when the mobile content or service's user accesses the WINC extension number through the mobile terminal; and converting the read mobile contents or service to cater to a size of the mobile terminal's screen, a resolution, or a supportable image.

In some exemplary embodiments, the method further comprises selecting one of mobile contents or service, an advertisement period and an advertisement position which an advertiser wants to insert; and uploading the advertiser's advertisement to an advertisement data base by the advertiser.

In some exemplary embodiments, the method further comprises uploading an advertiser's advertisement to an advertisement data base by the advertiser; reading the mobile contents or service corresponding the specific WINC extension number from the contents data base when a mobile contents or service user accesses the specific WINC extension number through the mobile terminal; inserting an mobile advertisement stored in the advertisement data base within the read mobile contents or service page; and converting the read mobile contents or service to cater to a size of the mobile terminal's screen, a resolution, or a supportable image.

In some exemplary embodiments, the mobile advertisement within the mobile contents or service page is inserted only when the mobile contents or service provider allows the insertion of the advertisement.

In some exemplary embodiments, wherein the charge fee of the WINC extension number is reduced or a separate point is added when the mobile contents or service provider allows the insertion of the advertisement.

An object of the present disclosure is provide a mobile service system comprising: a content data base configured to store a mobile contents or service; a advertisement data base configured to store various mobile contents advertisement; a mobile converting unit configured to convert a requested mobile contents or service stored in the contents data base to cater to a supportable image, a resolution, size of a screen, a supportable markup language in the mobile terminal, if a signal requesting the mobile contents or service is received from the mobile terminal through an internet network; and a controller configured to convert to cater to specification of the mobile terminal which is accessed in case that an insertion of the mobile terminal advertisement is allowed.

In some exemplary embodiments, a mobile service system further comprises a WINC extension number generating unit configured to generate and manage a WINC extension number; a controller configured to provide WINC extension number to the mobile contents or service provider by automatically generating the WINC extension number from the WINC extension generating unit or by generating a WINC extension number selected by the mobile contents or service provider if a signal for providing the WINC extension number is received.

In some exemplary embodiments, the mobile converting unit comprises a mobile terminal information configured to store various mobile terminal information; a contents generating unit configured to covert the mobile contents or service to a markup language which is applicable to the mobile terminal accessed by using the information stored in the mobile terminal information data base; and a resource converting unit configured to the mobile contents or service to cater to a size of a screen, a resolution, a supportable image in the accessed mobile terminal by using the information in the mobile terminal information data base.

In some exemplary embodiments, the controller is configured to read information corresponding to the mobile terminal information data base if the accessed mobile terminal is analyzed so that the mobile terminal's information is preexisted and is configured to control to store information in the mobile terminal information in case of a new mobile terminal where the stored information is extracted from information included in a header of an access request message from the mobile terminal.

In some exemplary embodiments, the mobile service system further comprises a communication module configured to communicate with a mobile terminal, wherein the controller is configured to transmit the converted mobile contents or service to the accessed mobile terminal by using the communication module.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of one embodiment of the mobile service system according to present disclosure;

FIG. 2 is a detailed block diagram of the mobile converting unit according to the present disclosure;

FIG. 3 is an image diagram illustrating a screen displaying the mobile contents or service where the advertisement is inserted, according to the present disclosure;

FIG. 4 is a flow chart related to the mobile service method according to the present disclosure; and

FIG. 5 is a flow chart related to the charge fee method using the mobile service system according to the present disclosure.

### DETAILED DESCRIPTION OF THE DISCLOSURE

Reference will now be made in detail to the preferred embodiments of the present disclosure, examples of which are illustrated in the accompanying drawings. Wherever possible, the same reference numbers will be used throughout the drawings to refer to the same or like parts.

A WINC number in the specification is defined as a mobile address which enables the mobile terminal to access a wireless internet contents through the number instead of inputting complicated URL(Uniform Resource Locator). For example, in case the URL is ‘www.yahoo.com’, the WINC number may ‘6003’. If the user inputs ‘6003’ by using the mobile terminal's key pad and presses a wireless connection button, the user may access the ‘www.yahoo.com’. The WINC number is not limited to ‘6003’. It should be understood that the various modifications of the WINC number are available. The WINC number may be a combination of symbol and number. Therefore, the user may access the corresponding URL address by inputting the WINC number (for example, “6003”) instead of inputting the complicated URL address (for example, “www.yahoo.com”). A public organization or an entertainment may provide the WINC number's management and its service. In Korea, NIDA (National Internet Development Agency) is providing the WINC number's management and its service.

A ‘WINC extension number’ in this specification is defined as a number adding an additional number to the WINC number. For example, the ‘WINC extension number’ is a number ‘7777’ or a symbol which is added to the WINC number.

The mobile terminal in this specification may be a cell phone, a smart phone, PDA, and so on.

The mobile contents or service in this specification is defined as contents or service which may be provided in the mobile terminal, not the PC (personal computer). The mobile contents or service is a concept including a phone page (phone+homepage).

In the following description, we will describe the present invention referring to the attached Figures.

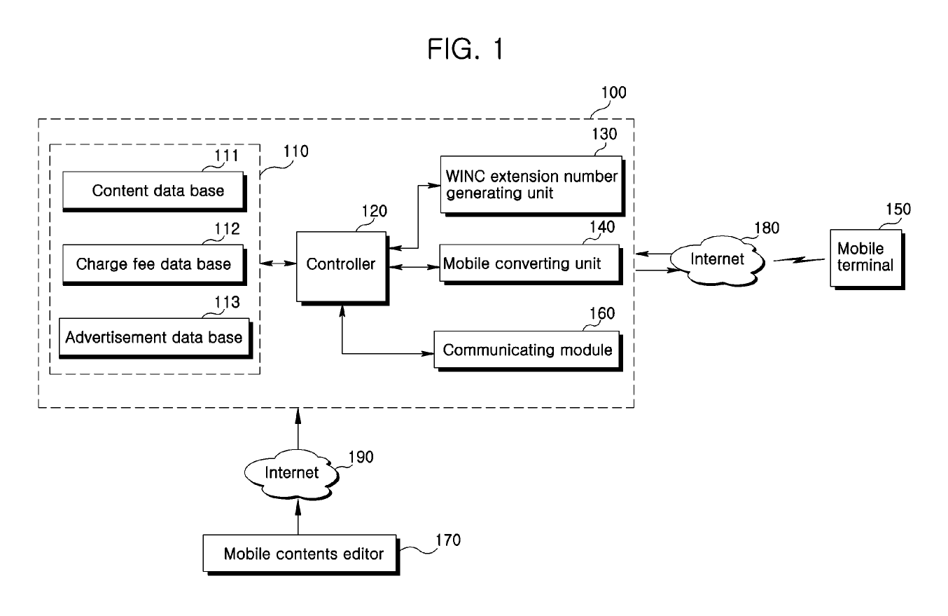

FIG. 1 is a block diagram of one embodiment of the mobile service system according to present disclosure.

Referring to FIG. 1, the mobile service system 100 of the present disclosure may include a data base unit 110, a controller 120, a WINC extension number generating unit 130, a mobile converting unit 140, and a communicating module 160.

A mobile contents or service provider produces the mobile contents or service by using various types of mobile contents editors 170. The mobile contents editor 170 is defined as a program which enables to produces the mobile contents or service. The mobile contents or service provider may access to the mobile service system 100 through an internet network 190, and may store the mobile content or service in the contents data base 111 of the data base unit 110. The program language which is used in producing the mobile contents or service may be a DIDL (Digital Item Declaration Language) according to the MPEG 21 Standard. Due to the DIDL, the mobile contents or service provider may more easily edit the mobile contents or service.

The data base 110 is configured to store the necessary data. The data base 110 may comprise a contents data base 111, a charge fee data base 112, and an advertisement data base 113.

The contents data base 111 is configured to upload the mobile contents or service which the mobile contents or service provider wish to provide.

Moreover, the mobile contents or service provider may access to the mobile service system to update the mobile contents or service stored in the contents data base 111. The mobile contents or service provider may access the mobile service system by using the wired internet network or the wireless internet network. For example, the mobile contents or service provider accesses the mobile service system 100 by using the mobile terminal. If the mobile contents or service provider corrects the subject matter of his mobile contents or service, the controller 120 stores the corrected information in the contents data base.

The charge fee data base 112 may store information on charge fee of the WINC extension number and a charge fee on the template/item per each contents or service provider. Alternatively, the charge fee may be covered by using the point or other concept.

The advertisement data base 113 may store various advertisements which the advertiser requests to insert in mobile contents and service. The mobile advertisement may be produced by the advertiser or producer who is using various editors.

The WINC extension number generating unit 130 generates a specific WINC extension number in order to provide a WINC extension number for mobile contents or service provider. The WINC extension number may be provided automatically, or the mobile contents or service may select a number which he wants. For example, if the mobile contents or service provider selects ‘7890’ as the WINC extension number, the WINC extension generating unit 130 generates the selected WINC extension number. The generated WINC extension number is provided to the mobile contents or service provider. Therefore, the mobile contents or service user may access the mobile contents or service by using the WINC number(for example, ‘6005#’) for accessing the mobile service system and the WINC extension number (for example, ‘7890’) for accessing the mobile contents or service provided by the mobile contents or service provider. The WINC extension generating unit 130 does not generate a WINC extension number which is same as the WINC extension number which has been generated, by storing the provided WINC extension number. Therefore, the WINC extension number generating unit may be prevented from being provided with the same WINC extension number.

The mobile converting unit 140 may convert a mobile content or service and a mobile advertisement to cater to the specification of the accessed mobile terminal. The mobile terminal 150 may comprise a controller, a wireless communication unit configured to communicate with an external device, a memory, and an output unit. Furthermore, the communication through the wireless internet network may be a best way to communicate between the mobile system 100 and the mobile terminal 150. In case the mobile contents or service user accesses to a mobile contents and service by using a specific WINC extension number, the controller 120 reads the mobile contents or service corresponding to the accessed WINC extension number from the contents data base 111. the controller 120 transmits the read mobile contents or service to the mobile converting unit 140. The mobile converting unit 140 converts the read mobile contents or service from the contents data base 111 to cater to the specification of the accessed mobile terminal 150.

The mobile converting unit 140 analyzes the specification information of the accessed mobile terminal 150. The specification of the mobile terminal 150 may include a size of the display, a type of the browser, a supportable markup language and so on.

The mobile converting unit 140 may insert the mobile advertisement in the mobile content or service. In case the insertion of advertisement in the mobile contents or service corresponding to a specific WINC extension number is allowed, the controller 120 reads the corresponding mobile advertisement from the advertisement data base 113. The controller 120 transmits the read mobile advertisement to the mobile converting unit 140. The controller 120 reads a mobile contents or service where the mobile advertisement from the contents data base 113 is to be inserted. The controller 120 transmits the read mobile contents or service to the mobile converting unit 140. The mobile converting unit 140 inserts the received mobile advertisement received within the mobile contents or service page. The mobile converting unit 140 converts the mobile contents or service where the mobile advertisement is inserted, to cater to a specification of an accessed mobile terminal 150. The controller transmits the converted mobile contents or service to the accessed mobile terminal by using the communication module 160. The internet 180 is used in communicating between the mobile service system 100 and the mobile terminal 150. The mobile terminal 150 is wirelessly connected to the internet 180. The mobile terminal may include a communication module capable of wireless-communication with an external device.

The communication module 160 may enable the mobile service system 100 to transmit/receive the data with the mobile terminal 150 or the mobile service system 100 to transmit/receive data with the mobile content editor 170. Namely, the communication module 160 is configured to be capable of transiting/receiving the data through internet (180,190).

The controller 120 may control to execute the identifying process by using an ID, a password, an owner identification of the mobile terminal, an owner identification of the credit card, so as to make the mobile contents or service provider use the WINC extension number.

If the mobile contents or service provider selects an automatic generating WINC extension number or a wish WINC extension number, the controller 120 controls in such a manner that the WINC extension number is generated according to the selection from the WINC extension number generating unit 130. The controller 120 controls to provide the generated the WINC extension number to the mobile contents or service provider.

In providing the WINC extension number, the controller 120 may control so that the mobile contents or service provider can select a use period time that he wants. The use period time that he wants may be an hour unit, a day unit, or a month unit. The controller 120 may control to charge the graded fee per each selected use period. For example, in case the mobile contents or service provider selects 2 hours as the WINC extension number use period, the controller 120 charges the fee corresponding 2 hours to the mobile contents or service provider. For another example, in case the mobile contents or service provider selects 10 minutes as the WINC extension number use period, the controller 120 charges the fee corresponding 10 minutes to the mobile contents or service provider. The controller 120 may control to charge the fee or to deduct it from the point. The controller 120 stores information in the charge data base 112, where the information is related to the charged fee, or the increased or decreased point. The controller 120 controls to charge various fee according to the service use of the present disclosure except for the process aforementioned.

The controller 120 may store information in the advertisement data base 113, where the information is related to the information whether the mobile contents service provider allows the mobile advertisement to be inserted, to the information on the selection of advertisement which the advertiser wants to insert, to the information on the position of the advertisement, and to the information on period of advertisement which he wants. The controller 120 controls to insert the mobile advertisement according to the mobile contents or service, the selected advertisement period, the position of advertisement in case that the mobile contents or service provider allows the advertisement stored in the advertisement data base 113 to insert. Moreover, in case the mobile contents or service include various pages, the controller 120 may control in such a manner that different advertisement can be inserted in each page.

The controller 120 controls to reduce the charge fee on the WINC extension number of the mobile contents or service, or to increase the point if the mobile contents or service provider allows the advertisement.

The controller 120 controls to store a updated information in the contents data base 111 if the mobile contents or service provider or the mobile contents or service user updates the mobile contents or service.

When the mobile contents or service user selects (clicks) the mobile advertisement, the controller 120 controls to automatically access the corresponding site. The site may be a mobile site or wired web site.

If the user selects to transmit the SMS including the mobile address to the specific terminal, the controller 120 transmits the SMS including a mobile address to a specific terminal. If the user of the specific mobile terminal selects the mobile address in the SMS, the specific mobile terminal automatically accesses mobile contents or service corresponding mobile address.

The controller 120 controls allotment of a space so that the mobile contents or service can be uploaded in case that the mobile contents or service provider is provided with the WINC extension number.

If the mobile contents or service provider uploads the mobile contents or service, the controller 120 controls to store the uploaded information on the allotted space within the contents data base 111.

According to the present disclosure, the mobile content or service provider may reduce the charge fee on the mobile address since the mobile address is used for a short period of time due to the WINC extension number.

Moreover, the advertiser saves the fee for the advertisement, and the mobile contents or service provider may use the mobile service with cheaper cost or free of charge by allowing the advertisement.

Furthermore, the mobile contents or service provider need not install a separate server for providing the mobile contents or service.

In addition, the mobile contents or service may be provided to any mobile terminal.

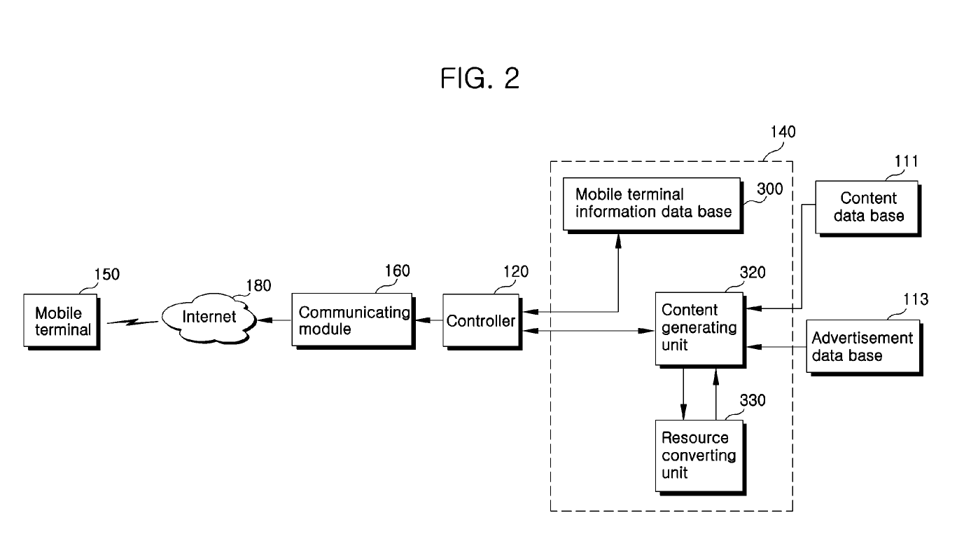

FIG. 2 is a detailed diagram of mobile converting unit according to the present disclosure.

Referring to FIG. 2 and FIG. 1, the mobile converting unit 140 according to the present disclosure may include a mobile terminal information data base 300, a contents generating unit 320, and a resource converting unit 330.

The mobile terminal information data base 300 may store information of various types of mobile terminals, such as browser information, supportable markup language, image type or size of screen.

The controller 120 analyzes a type of the mobile terminal included in a header of a access request message, when the mobile terminal 150 requests the service access by using a specific WINC extension number. As a result of the analysis, if the information on the corresponding type of mobile terminal is stored in the mobile terminal information data base 300, the controller 120 receives the corresponding information from the mobile terminal information data base 300. On the other hand, if the information on the corresponding type of mobile terminal is not stored in the mobile terminal information data base 300, the controller 120 analyzes the information, such as browser information, supportable markup language, image type or size of screen, of the mobile terminal 150, and stores the information of the mobile terminal 150 to the mobile terminal information data base 300.

Accordingly, in case that the information of the accessed mobile terminal 150 is stored in the mobile terminal information data base 300, the controller 120 need not to separately analyzes the header and directly receives the information of the mobile terminal 150 from the mobile terminal information data base 300. Therefore, the entire system speed will be improved.

In the following description, the information on the markup language, a supportable screen size and image type used in the contents generating unit 320 and the resource converting unit 330 is obtained from the mobile terminal information data base 300.

The contents generating unit 320 receives the mobile contents or service corresponding to those of the accessed WINC extension number from the contents data base 111, if the convert request signal is received from the controller 120. The contents generating unit 320 transmits the received mobile contents or service to the resource converting unit 330.

The contents generating unit 320 converts the received mobile contents or service to the markup language which the accessed mobile terminal may support. The examples of the markup language are WML (wireless markup language), MHTML(mobile hypertext markup language), XHTML(Extensible Hypertext Markup Language), and so on. The contents generating unit 320 transmits the converted mobile contents or service to the accessed mobile terminal 150.

The resource converting unit 330 converts the received mobile contents or service to cater to the supportable screen size and the type of the image, and transmits the converted mobile contents or service to the contents generating unit 320.

In another embodiment, the contents generating unit 320 may insert the advertisement to the mobile contents or service. If the mobile contents or service provider allows the advertisement, the contents generating unit 320 receives the mobile contents or service corresponding the WINC extension number from the contents data base 111 and the allowed advertisement from the advertisement data base 113. The contents generating unit 320 inserts the allowed advertisement to the mobile contents or service. The contents generating unit 320 transmits the mobile contents or service where the advertisement is inserted to the resource converting unit 330.

Moreover, the contents generating unit 320 converts the mobile contents or service where the advertisement is inserted to markup language which the accessed mobile terminal 150 may support. The contents generating unit 320 transmits the converted mobile contents or service to the controller 120. The controller 120 transmits the converted mobile contents or service to the mobile terminal 150 by using the communication module 160.

The resource converting unit 330 converts the received mobile contents or service to cater to the screen size and the image type which the accessed mobile terminal 150 can support. The resource converting unit 330 also transmits the converted mobile contents or service to the convert generating unit 320.

As shown in the aforementioned, it has advantages that the mobile contents or service may be provided regardless of communication companies or types of mobile terminals.

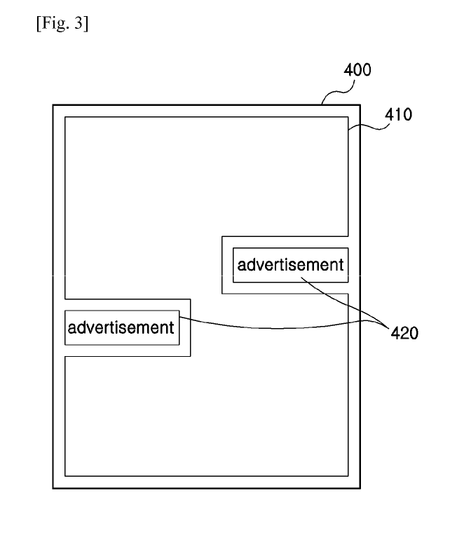

FIG. 3 is a diagram illustrating a screen where the mobile content or service where the advertisement is inserted is displayed, according to the present disclosure.

Referring to the FIG. 3, a screen 400 may include mobile contents or service 410 and an advertisement 420.

The mobile contents or service 410 and the advertisement 420 are displayed on the screen 400 at the same time. The positions of the mobile contents or service 410 and the advertisement 420 may be modified.

As shown in the aforementioned, the mobile contents or service provider may create a profit or use the mobile service with cheap price by allowing the insertion of advertisement. The advertiser may advertise efficiently and cheaply by selecting the mobile contents or service that he wants.

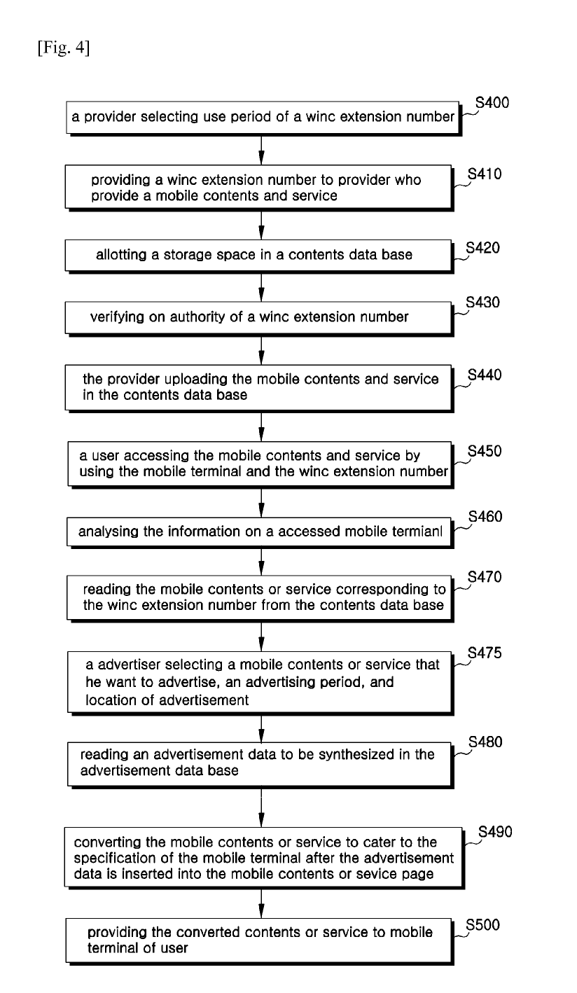

FIG. 4 is a flow chart of mobile service method according to the present disclosure.

The mobile contents or service provider selects the use period of the WINC extension number as much as he wants (S400). For example, the mobile contents or service provider may select one of 1 hour, 5 hour, and 1 day as the use period of the WINC extension number. Moreover, the mobile contents or service provider may select various items such as a music, template, and icon for constituting the mobile contents or service, as well as the selection of use period of the WINC extension number. If the mobile contents or service provider selects the use period of the WINC extension number and various items, the corresponding cost is requested or the point is reduced.

If the mobile contents or service provider selects the WINC extension number automatically or manually, the controller 120 generates the corresponding WINC extension number through the WINC extension number generating unit 130 to provide the WINC extension number to the mobile contents or service provider (S410).

The controller 120 allots a space in the contents data base 111 so that the mobile contents or service provider who receives the WINC extension number can update (S420).

When the mobile contents or service provider accesses his mobile contents or service, whether he has an authority to use the WINC extension number is verified (S430). After the verification, the mobile contents or service provider uploads the mobile contents or service which he produces in the contents data base 111 (S440).

The mobile contents or service user may access mobile contents or service by using the mobile terminal and the WINC extension number (S450). For example, the mobile contents or service user accesses the mobile service system by using a WINC number. The mobile contents or service user accesses the mobile contents or service which is provided the mobile service system by using a WINC extension number. The controller 120 analyzes the specification of the accessed mobile terminal (S460). The controller 120 transmits the mobile contents or service corresponding to the accessed WINC extension number to the mobile converting unit 140 by reading the mobile contents or service from the contents data base 111.

The advertiser who want to advertise may select the publication condition such as the mobile contents or service that he want to advertise, the period that he want, and the fee for advertisement (S475).

The advertiser may upload the publishing advertisement in the advertisement data base 113. In the case that the insertion of the advertisement on the mobile contents or service is requested, the controller 120 reads the mobile advertisement to be inserted in the mobile contents or service from the advertisement data base 113 to transmit to the mobile contents converting unit 140 (S480).

The mobile converting unit 140 inserts the received advertisement within the mobile contents or service page. The mobile converting unit 140 converts the mobile contents or service inserted with advertisements to cater to the specification of the accessed mobile terminal (S490).

The controller 120 transmits the mobile contents or service converted by the mobile converting unit 140 to the accessed mobile terminal (S500).

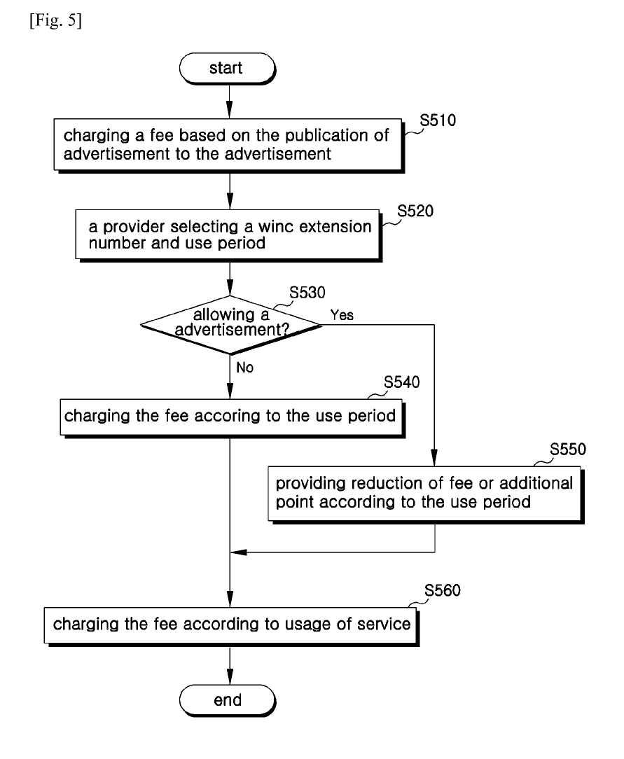

FIG. 5 is a flow chart related to the method for charging fee, the method using the mobile service system according to the present disclosure.

Referring to the FIG. 5 and FIG. 1, the advertiser wishes to advertise his advertisement through the mobile contents or service. The controller 12 charges the fee based on a standard which the advertiser selects (S510). The standard may be one of the time of the advertisement, a total advertise period, the number of the mobile contents or service to be advertised, a area of ratio the advertisement in the mobile content or service. The controller 120 stores the charge fee information in the charge fee data base. The method for charging fee may use a credit card payment, a cell phone payment, or an automatic transaction payment. Alternatively, the off-line payment may be also used in the method for charging fee such as the account transaction and the cash transaction.

The mobile contents or service provider may select the WINC extension number and the use period which he wants, for using the mobile service during the certain period (S520). The WINC extension number is optionally or automatically granted. Alternatively, the period that the user wishes to use will be selected in the standard of a minute, a hour, a time, a day, a day of week, a month.

The mobile contents or service provider selects whether the insertion of the advertisement is allowed (S530). If the provider does not allow the insertion of the advertisement, the controller 120 controls to charge the use fee without any deduction (S540).

On the other hand, if the provider allows the insertion of the advertisement, the controller 120 controls to reduce the charge fee for the WINC extension number which the provider uses or to provide a point additionally. The ratio of reduction and the point will be decided voluntarily. The controller 120 stores the charge fee information on the charge fee data base.

The controller 120 may charge the fee according to use of the mobile contents or service. Also, the controller 120 may charge the additional fee according to use of the other service (S560). The other service can be one of the additional service and the transmission service. The additional service can be a template, an icon, an averter, a service informing a reply on the mobile contents or service, and a service for extending the period of the WINC extension number. The transmission service is a service transmitting a message including a WINC extension number or a content which enables to link his mobile contents or service. The service may be modified or added as well as aforementioned services.

Accordingly, the mobile contents or service provider may use the mobile service more cheaply by allowing the mobile advertisement to be inserted. Namely, the mobile contents or service provider may receive the reduction of a charge fee or the additional point. Moreover, the advertiser may insert the mobile advertise to the mobile contents or service that he wants. He also may determine the advertisement time and he may advertise the mobile advertisement with cheap cost.

It is to be understood that both the aforementioned general description and the detailed description of the present disclosure are exemplary and explanatory and are intended to provide further explanation of the invention as claimed.

What is claimed is:

1. A mobile service system comprising:
a WINC extension number generating unit configured to manage and to generate a WINC extension number; and
a controller configured to control the extension number generating unit to automatically generate the WINC extension number, or to generate the WINC extension number which a mobile content or service provider selects in order to provide the WINC extension number to a mobile content or service provider, if a signal for receiving the WINC extension number is received.

2. The mobile service system of the claim 1, further comprising a charging data base configured to store information on a charge for the each mobile content or service provider,
wherein the controller is configured to charge the fee according to a use period selection of the WINC extension number, and to control to store a charged charge information in the charging data base.

3. The mobile service system of the claim 1, further comprising a charging data base configured to store information on a charge for the each mobile content or service provider,
wherein, the controller configured to control to reduce a charge fee or provide an additional point, and to store information on reduction of the charge fee and the additional point in the charge data base, in case that the mobile contents or service provider allows an insertion of mobile advertisement.

4. The mobile service system of the claim 1, further comprising
a contents data base configured to store mobile contents or services; and
a mobile converting unit configured to convert requested mobile contents or services stored in the contents data base to cater to an image, a resolution, a size of a screen, and a mark-up language which are able to be supported in a mobile terminal, if the signal requesting a specific mobile contents or services is received to the mobile terminal through an internet network.

5. The mobile service system of the claim 4,
wherein the mobile converting unit comprises
a mobile terminal information data base configured to store information of various mobile terminals;
a contents generating unit configured to convert the mobile contents or service to the mark up language supported by the mobile terminal by using the information stored in the mobile terminal information data base; and
a resource converting unit configured to convert the mobile contents or services to cater to an image, a resolution, a size of a screen, and a mark-up language which are able to be supported in the mobile terminal by using the information stored in the mobile terminal information data base.

6. The mobile service system of the claim 5,
wherein the controller is configured to control the contents generating unit to transmit the mobile contents or service to the resource converting unit or to convert a converted mobile contents transmitted from the resource converting unit or service to the markup language which mobile terminal supports if the signal for converting the mobile contents or service to cater to the specification of the mobile terminal is received.

7. The mobile service system of the claim 6,
wherein controller is configured to control the resource converting unit to convert the received mobile contents or service to cater to the size of mobile terminal's screen, a resolution, an supportable image so as to transmit to the contents generating unit if the mobile contents or service is transmitted from the contents generating unit.

8. The mobile service system of the claim 5,
Wherein the controller is configured to read information corresponding to the mobile terminal information data base if the accessed mobile terminal is analyzed so that the mobile terminal's information is preexisted and is configured to control to store information in the mobile terminal information in case of a new mobile terminal where the stored information is extracted from information included in a header of an access request message from the mobile terminal.

9. The mobile service system of the claim 4, further comprising a communication module configured to communicate with a mobile terminal,
wherein the controller is configured to transmit the converted mobile contents or service to the accessed mobile terminal by using the communication module.

10. The mobile service system of the claim 1,
wherein the controller is configured to transmit a SMS to a specific mobile terminal when a signal for sending the SMS including the mobile address to the specific mobile terminal is received, wherein the SMS is for automatically accessing to the mobile address if the mobile address is selected.

11. A mobile service method comprising:
selecting a item by a user, the item for constituting at least one of a WINC extension use period and mobile contents or service
providing a WINC extension number to the mobile contents or service provider by generating the WINC extension number selected by the mobile contents or service or automatically generated from a WINC extension number generating unit if the use period of the WINC extension number is selected; and
uploading the mobile contents or service in a contents data base by the mobile contents or service provider.

12. The method of claim 11, further comprising:
reading the mobile contents or service corresponding the specific WINC extension number from the contents data base when the mobile content or service's user accesses the WINC extension number through the mobile terminal; and
converting the read mobile contents or service to cater to a size of the mobile terminal's screen, a resolution, or a supportable image.

13. The method of the claim 11, further comprising:
selecting one of mobile contents or service, an advertisement period and an advertisement position which an advertiser wants to insert; and
uploading the advertiser's advertisement to an advertisement data base by the advertiser.

14. The method of the claim 11, further comprising:
uploading an advertiser's advertisement to an advertisement data base by the advertiser;
Reading the mobile contents or service corresponding to the specific WINC extension number from the contents data base when a mobile contents or service user accesses the specific WINC extension number through the mobile terminal;
inserting an mobile advertisement stored in the advertisement data base within the read mobile contents or service page; and
converting the read mobile contents or service to cater to a size of the mobile terminal's screen, a resolution, or a supportable image.

15. The method of the claim 14,
wherein the mobile advertisement within the mobile contents or service page is inserted only when the mobile contents or service provider allows the insertion of the advertisement.

16. The method of the claim 14,
wherein the charge fee of the WINC extension number is reduced or an separate point is added when the mobile contents or service provider allows the insertion of the advertisement

17. A mobile service system comprising:
a content data base configured to store a mobile contents or service;
an advertisement data base configured to store various mobile contents advertisement;
a mobile converting unit configured to convert a requested mobile contents or service stored in the contents data base to cater to a supportable image, a resolution, size of a screen, a supportable markup language in the mobile terminal, if a signal requesting the mobile contents or service is received from the mobile terminal through an internet network; and
a controller configured to convert to cater to specification of the mobile terminal which is accessed in case that an insertion of the mobile terminal advertisement is allowed.

18. A mobile service system of the claim 17, further comprising:
a WINC extension number generating unit configured to generate and manage a WINC extension number;
a controller configured to provide WINC extension number to the mobile contents or service provider by automatically generating the WINC extension number from the WINC extension generating unit or by generating a WINC extension number selected by the mobile contents or service provider if a signal for providing the WINC extension number is received.

19. The mobile service system of the claim 17,
wherein the mobile converting unit comprising:
a mobile terminal information configured to store various mobile terminal information;
a contents generating unit configured to covert the mobile contents or service to a markup language which is applicable to the mobile terminal accessed by using the information stored in the mobile terminal information data base; and
a resource converting unit configured to the mobile contents or service to cater to a size of a screen, a resolution, a supportable image in the accessed mobile terminal by using the information in the mobile terminal information data base.

20. The mobile service system of the claim 17,
wherein the controller is configured to read information corresponding to the mobile terminal information data base if the accessed mobile terminal is analyzed so that the mobile terminal's information is preexisted and is configured to control to store information in the mobile terminal information in case of a new mobile terminal where the stored information is extracted from information included in a header of an access request message from the mobile terminal.
